(19) United States
(12) Patent Application Publication
(10) Pub. No.: US 2025/0217590 A1
(43) Pub. Date: Jul. 3, 2025

(54) DATA PROCESSING DEVICE AND METHOD THEREOF

(71) Applicant: INDUSTRIAL TECHNOLOGY RESEARCH INSTITUTE, Hsinchu (TW)

(72) Inventors: Tsung-Ling HWANG, Hsinchu City (TW); Shu-Hao YE, Zhudong Township (TW)

(73) Assignee: INDUSTRIAL TECHNOLOGY RESEARCH INSTITUTE, Hsinchu (TW)

(21) Appl. No.: 18/397,784

(22) Filed: Dec. 27, 2023

(51) Int. Cl. G06F 40/279; G06F 16/332; G06F 16/34

(52) U.S. Cl. CPC G06F 40/279; G06F 16/3329; G06F 16/345

(57) ABSTRACT

A data processing device, for providing a pre-training data for a language model, includes the following elements. A collection unit, for receiving a first dataset having a first category. An evaluation unit, for analyzing the first dataset to generate a category analysis result, evaluating the first dataset based on several of indicators of an evaluation rule to generate a first evaluation result, and determining whether the first evaluation result meets an evaluation criteria. A feedback unit, for converting and aggregating the first evaluation result to generate a first evaluation summary which is sent to the collection unit. A storage unit, for selectively storing the first dataset based on the first evaluation result. When the first evaluation result meets the evaluation criteria, the storage unit stores the first dataset which serves as the pre-training data. Otherwise, the evaluation unit provides several suggestions of adjustment for the first dataset.

### TECHNICAL FIELD

The present disclosure relates to a data processing mechanism, and in particular relates to a data processing device and a method thereof which are applied for pre-training a language model.

### BACKGROUND

In artificial intelligence (AI) technology, when a computational model is constructed and pre-trained, the computational model needs to be inputted with a high-quality dataset. Especially for a language model, high-quality datasets are usually created by humans (i.e., natural persons). Human-generated datasets can cover diverse, multi-vocalic, and multi-semantic expressions. High-quality datasets can improve the inference performance of the language model.

However, when collecting datasets created by humans, it takes a lot of manpower to evaluate and filter the datasets, which requires high labor costs and time costs. Moreover, manual evaluation and filtering may limit the depth and breadth of data collection. Furthermore, datasets that have not been reviewed by experts (for example, datasets randomly obtained through the Internet) may have the following shortcomings: insufficient diversity of the datasets which results in model degradation, erroneous inference results, bias discrimination, misleading, poor quality of training convergence, or copyright disputes, etc. In addition, the post-processing cost of fine-tuning the language model for specific tasks is also high.

Based on the above issues, an improved data processing mechanism is needed, which provides high-quality datasets as pre-training data for the language model.

### SUMMARY

According to one embodiment of the present disclosure, a data processing device for providing a pre-training data for a language model is provided. The data processing device includes the following elements. A collection unit, for receiving a first dataset, and the first dataset has a first category. An evaluation unit, for analyzing the first dataset based on the first category to generate a category analysis result, evaluating the first dataset based on a plurality of indicators of an evaluation rule to generate a first evaluation result, and determining whether the first evaluation result meets an evaluation criteria. A feedback unit, for converting and aggregating the first evaluation result to generate a first evaluation summary, and transmitting the first evaluation summary to the collection unit. A storage unit, for selectively storing the first dataset based on the first evaluation result. Wherein, when the first evaluation result meets the evaluation criteria, the storage unit stores the first dataset and the first dataset serves as the pre-training data, when the first evaluation result does not meet the evaluation criteria, the evaluation unit provides a plurality of suggestions of adjustment for the first dataset.

According to another embodiment of the present disclosure, a data processing method for providing a pre-training data for a language model is provided. The data processing method includes the following steps. Receiving a first dataset by a collection unit, and the first dataset has a first category. Analyzing the first dataset based on the first category to generate a category analysis result, evaluating the first dataset based on a plurality of indicators of an evaluation rule to generate a first evaluation result, and determining whether the first evaluation result meets an evaluation criteria, by an evaluation unit. Converting and aggregating the first evaluation result to generate a first evaluation summary by a feedback unit. Selectively storing the first dataset based on the first evaluation result, by a storage unit. When the first evaluation result meets the evaluation criteria, the following steps are performed: storing the first dataset by the storage unit, and providing the first dataset as the pre-training data. When the first evaluation result does not meet the evaluation criteria, the following steps are performed: providing a plurality of suggestions of adjustment for the first dataset by the evaluation unit.

By reading the following drawings, detailed description and claims, other aspects and advantages of the present disclosure may be comprehended.

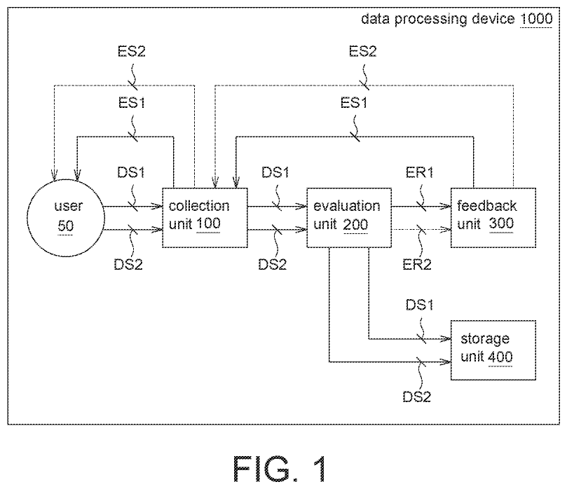

FIG. 1 is a functional block diagram of a data processing device 1000 based on an embodiment of the present disclosure.

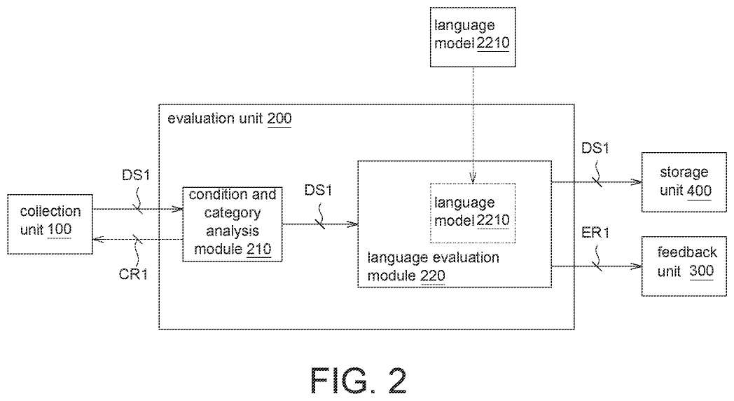

FIG. 2 is a functional block diagram of the evaluation unit, and illustrates the operation of the evaluation unit.

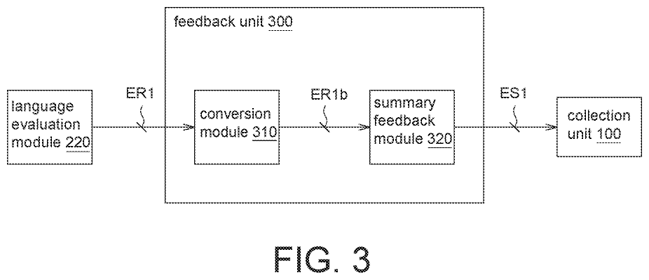

FIG. 3 is a functional block diagram of the feedback unit, and illustrates the operation of the feedback unit.

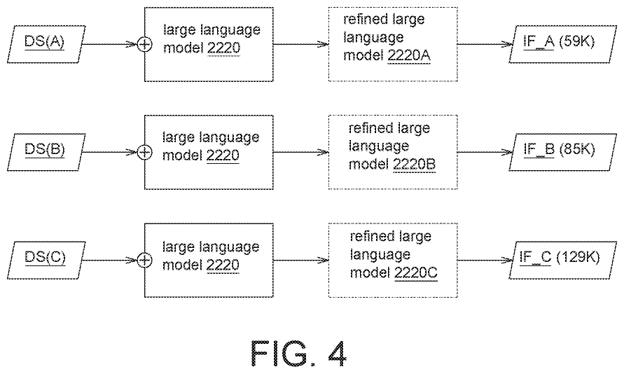

FIG. 4 illustrates a schematic diagram of performance of a language model trained by diverse datasets.

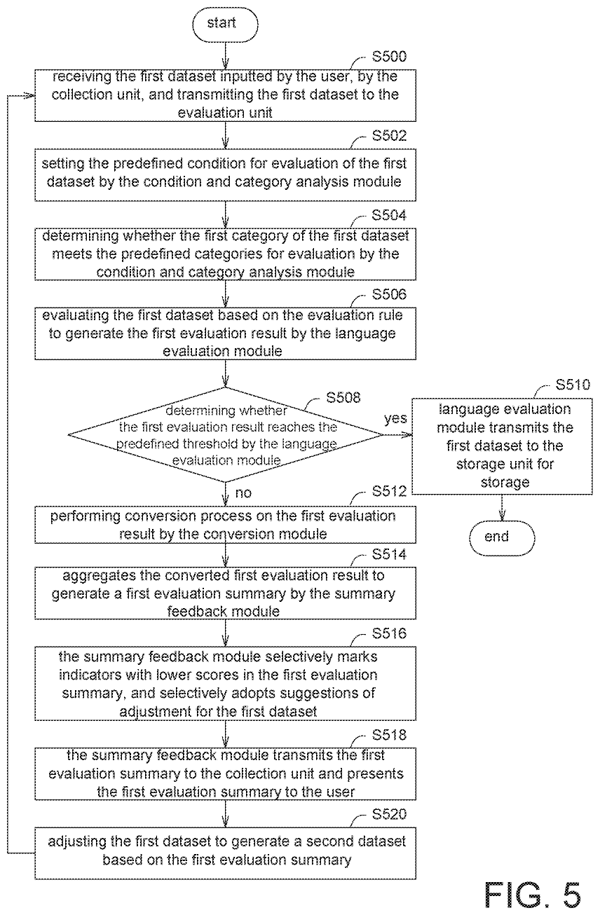

FIG. 5 is a flow chart of a data processing method based on an embodiment of the present disclosure.

### DETAILED DESCRIPTION

The technical terms in this specification refer to ordinary terms in this technical field. If this specification has explanations or definitions for some terms, the explanations or definitions of these terms shall prevail. Each embodiment of the present disclosure has one or more technical features. To the extent possible, a person with ordinary skill in this art may selectively practice some or all of the technical features in any embodiment, or selectively combine some or all of the technical features in these embodiments.

Please refer to FIG. 1, which is a functional block diagram of a data processing device 1000 based on an embodiment of the present disclosure. The data processing device 1000 includes a collection unit 100, an evaluation unit 200, a feedback unit 300 and a storage unit 400. In one example, the data processing device 1000 is a software program that can be installed and executed on a host device, and the host device is e.g., a desktop computer, a notebook computer, a workstation, or a mobile computing device. In another example, the data processing device 1000 is a hardware component, e.g., a processor, a micro-controller, or an application specific integrated circuit (ASIC), which can cooperate with the host device. The collection unit 100, the evaluation unit 200 and the feedback unit 300 are respectively software modules or hardware components in the data processing device 1000. The storage unit 400 is a hardware component in the data processing device 1000, e.g., a memory or a physical/virtual hard disk. Alternatively, the storage unit 400 is, e.g., a local database or a remote database (such as a cloud storage space).

The coupling manner and operations of the collection unit 100, the evaluation unit 200, the feedback unit 300 and the storage unit 400 are described as follows. Please refer to FIG. 1 again, the collection unit 100 includes a user interface for receiving a first dataset DS1 inputted by the user 50, which has a text format or a voice format. The collection unit 100 may also execute an auxiliary inputting program to facilitate the user 50 to input the first dataset DS1 in a simple and rapid manner. The first dataset DS1 is a pre-training data (or referred to as pre-training corpus), which may be used to pre-train the language model.

The evaluation unit 200 is coupled to the collection unit 100 to receive the first dataset DS1. The evaluation unit 200 is used to set a predefined condition, and analyze the first dataset DS1 based on the first category TP1 of the first dataset DS1, so as to generate a category analysis result CR1. Then, the evaluation unit 200 evaluates the first dataset DS1 based on an evaluation rule RL, so as to generate a first evaluation result ER1.

FIG. 2 is a functional block diagram of the evaluation unit 200, and illustrates the operation of the evaluation unit 200. Please refer to both FIGS. 1 and 2, the evaluation unit 200 includes a condition and category analysis module 210 and a language evaluation module 220. The condition and category analysis module 210 is used to set a predefined condition for the evaluation of the first dataset DS1. The predefined condition includes, e.g., indicators and weights of the evaluation rule RL, and a set of initial prompts for the evaluation. The indicators of the evaluation rule RL include, e.g., accuracy, rationality, creativity, readability, completeness, language expression, structure and organization, clarity and diversity, etc., and the above indicators each has a respective weight. Moreover, when the user 50 inputs the first dataset DS1, the user 50 also inputs the initial prompts. The initial prompts are provided to the evaluation unit 200 for evaluation, as shown in Table 1. The initial prompts may be presented to the user 50 through a user interface of the collection unit 100.

TABLE 1
Now, please serve as an evaluator, and the following are regulations for your evaluation:
When you receive a dataset to be evaluated (including a question and an answer, a
paragraph of text plus key excerpts, or an open question-answer, etc.), you can use integers
(excluding decimals) to make a rating for the dataset. Scores range from one to ten. Ten
points are awarded for the best degree, and one point for the worst degree.
The basic principles and reference standards for evaluation are as the following examples:
1. If the content of the dataset lacks logic, lacks correct relationships, or are wrong answers,
please give zero points.
2. The content of the dataset has low logic, partially correct relationships, or partially
incorrect answers, please give low to medium scores.
3. If the content of the dataset has appropriate logic, correct relationships, or has no wrong
answers, please give medium to high scores.
4. If the content of the dataset has appropriate logic, correct relationships, and has no wrong
answers, or has rich content, please give high scores.
The evaluation indicators include: correctness, creativity, readability, completeness and
rationality of the dataset. Please give scores respectively, and weight the scores of each
indicator based on the weight to get the total score, ranging from one to ten points.
After scoring, please give conclusions based on the evaluation indicators. Also, please
describe the shortcomings of the current dataset for the two lower-scored indicators and
provide suggestions for adjustment.

Furthermore, the condition and category analysis module 210 is used to analyze the first category TP1 of the first dataset DS1 to determine whether the first category TP1 conforms to predefined categories of the evaluation and generate the category analysis result CR1. The predefined categories are dataset categories that the evaluation unit 200 can process, including: the open question and answer category, the closed question and answer category, the abstract and text information extraction category, the scientific and mathematical data categories, the literature, history and legal data category, the artistic data category, or the creativity data category. Moreover, the datasets of each category can have the question and answer format, the abstract format, the selection format or the narrative format. The question-and-answer-format dataset must have “questions” and “answers”. The abstract-format dataset must have “previous text” and “later text”, and the length of the data in the latter text is greater than the length of the data in the previous text. The selection-format dataset must have “questions” and “multiple-choice answers”. The narrative-format datasets must be text that is larger than the predefined data length. The example in Table 2 is a matching and comparison between the first category TP1 of the first dataset DS1 and the predefined categories, where the first category TP1 is, e.g., an open question and answer dialogue, a closed question and answer dialogue, a legal knowledge, a short poem or a daily greeting.

TABLE 2

| | The first category TP1 |
|---|---|
| Predefined categories | of the first dataset DS1 |
| Open Q&A category | Open Q&A dialogue (V) |
| Closed Q&A category | Closed Q&A dialogue (V) |
| Abstract and text | |
| information extraction | |
| category | |
| Scientific and mathematics data | |
| category | |
| Literary, history and | Legal knowledge (V) |
| legal data category | |
| Artistic data category | Short poem (V) |
| Creativity data category | |
| | Daily greeting (X) |

In the example of Table 2, when the condition and category analysis module 210 analyzes that the first category TP1 of the first dataset DS1 is an open question and answer dialogue, it conforms to the open question and answer category among the predefined categories, and the category analysis result CR1 indicates that the first dataset DS1 may comply with the predefined categories for evaluation (i.e., the first dataset DS1 is a dataset category that the evaluation unit 200 can process). Furthermore, the first dataset DS1 is sent to the subsequent language evaluation module 220 for processing. Similarly, when the first category TP1 of the first dataset DS1 is a closed question and answer dialogue, a legal knowledge, or a short poem, it respectively conforms to the closed question and answer category, the literature, history and legal data category or the artistic data category among the predefined categories, which means that the first dataset DS1 is a dataset type that the evaluation unit 200 can process, hence, the first dataset DS1 is generated. On the other hand, when the first category TP1 of the first dataset DS1 is a daily greeting and does not meet any of the predefined categories, the condition and category analysis module 210 transmits the category analysis result CR1 to the collection unit 100. The collection unit 100 presents the category analysis result CR1 to the user 50, and the category analysis result CR1 indicates that the first dataset DS1 does not meet the predefined category for evaluation, and datasets of other categories must be re-entered. Based on the above, when the first category TP1 of the first dataset DS1 meets the predefined categories, the first dataset DS1 can be sent to the subsequent language evaluation module 220.

The language evaluation module 220 evaluates the first dataset DS1 based on the evaluation rule RL to generate the first evaluation result ER1. As mentioned above, various indicators and corresponding weights of the evaluation rule RL can be set by the condition and category analysis module 210. Alternatively, the language evaluation module 220 can use the language model 2210 to define the evaluation rule RL. The language model 2210 may be an external large language model (LLM), such as ChatGPT of the OpenAI, or LLaMA2 and Vicuna which are open source programs, etc.

Taking the five indicators “correctness”, “creativity”, “readability”, “completeness” and “rationality” of the evaluation rule RL as an example, explaining how the language evaluation module 220 generates the first evaluation result ER1. The first dataset DS1 is, for example, a closed question and answer dialogue. The question part of the first dataset DS1 is: “When you have difficulties, how should you ask for help from others to find a solution?”. The answer part of the first dataset DS1 is: “When having difficulties, you should take the initiative to seek help from people you trust, share problems, listen to suggestions, and find solutions together.” The language evaluation module 220 evaluates the first dataset DS1 (especially evaluates the answer part) based on the indicators “correctness”, “creativity”, “readability”, “completeness” and “rationality”. The individual scores obtained for the above indicators are 8 points, 5 points, 9 points, 6 points and 8 points. Furthermore, the language evaluation module 220 performs a weighted calculation on the above individual scores to obtain the first evaluation result ER1 with a total score of 7.4 points, as shown in Table 3-1.

TABLE 3-1

| | | Individual | Weighted | First evaluation |
|---|---|---|---|---|
| Indicators | Weight | score | score | result ER1 |
| Correctness | 0.3 | 8 | 2.4 | 7.4 |
| Creativity | 0.2 | 5 | 1.0 | |
| Readability | 0.2 | 9 | 1.8 | |
| Completeness | 0.1 | 6 | 0.6 | |
| Rationality | 0.2 | 8 | 1.6 | |

Furthermore, the language evaluation module 220 determines whether the first evaluation result ER1 meets the evaluation criteria. The evaluation criteria include, for example: a predefined threshold for each score of each indicator (in this embodiment, the predefined threshold for each indicator can be set to the same value (for example, 8 points)). When the individual scores of indicators in the first evaluation result ER1 reach the predefined threshold, the language evaluation module 220 determines that the first evaluation result ER1 meets the evaluation criteria. In the example in Table 3-1, the indicators “creativity” and “completeness” have low scores, and their individual scores (i.e., 5 points and 6 points) are both lower than the predefined threshold (i.e., 8 points), indicating that the first evaluation result ER1 does not meet the evaluation criteria, and the first dataset DS1 failed to pass the evaluation. Therefore, it is determined that the first dataset DS1 originally provided by the user 50 does not reach the predefined quality and cannot be adopted as a pre-training data. At this time, the evaluation unit 200 provides suggestions of adjustment for the first dataset DS1 to the user 50. For example, the evaluation unit 200 generates a first evaluation summary ES1, and the first evaluation summary ES1 comprises the suggestions of adjustment for the first dataset DS1. Based on the suggestions of adjustment of the first dataset DS1, the user 50 can know the reason why the first dataset DS1 does not reach the predefined quality, and can adjust the first dataset DS1 based on the suggestions of adjustment, so as to obtain the second dataset DS2.

More specifically, the language evaluation module 220 of the evaluation unit 200 can further target the indicators “creativity” and “completeness” with lower scores in the first dataset DS1 (for example, individual score is lower than the predefined threshold) and generate suggestions of adjustment, allowing the user 50 to know the reason why the first dataset DS1 does not reach the predefined quality, and provides the user 50 with a direction for adjusting the first dataset DS1. Suggestions of adjustment may be in the form of text, for example: “Suggestions of adjustment for creativity: the answer part lacks novelty, and it is recommended to add unique strategies or insights from different fields” and “Suggestions of adjustment for completeness: the answer part only provides a basic framework, but lacks operational details and steps, and it is recommended to comprise specific guidance (for example, how to identify trustworthy people).” The above suggestions of adjustment are also adopted in the first evaluation result ER1. The language evaluation module 220 sends the first evaluation result ER1 to the feedback unit 300.

FIG. 3 is a functional block diagram of the feedback unit 300, and illustrates the operation of the feedback unit 300. Please refer to both FIGS. 1 and 3, the feedback unit 300 is coupled to the evaluation unit 200 to receive the first evaluation result ER1, and convert and aggregate the first evaluation result ER1 to generate the first evaluation summary. ES1. More specifically, the feedback unit 300 includes a conversion module 310 and a summary feedback module 320. The conversion module 310 receives the first evaluation result ER1 from the language evaluation module 220 of the evaluation unit 200, and performs conversion processing on the first evaluation result ER1, so as to convert the first evaluation result ER1 into text, numbers, graphics or images with appropriately arranged formats, based on which the converted first evaluation result ER1b is generated. For example, the converted first evaluation result ER1 b can selectively mark indicators with lower scores in a graphical form (for example, mark indicators “creativity” and “completeness” with lower scores than the predefined threshold).

The summary feedback module 320 receives the converted first evaluation result ER1b from the conversion module 310, and aggregates the converted first evaluation result ER1 b to generate a first evaluation summary ES1. The first evaluation summary ES1 has a more streamlined and bright format to facilitate users 50 to quickly understand the evaluation results of the first dataset DS1. Table 3-2 is an example of the first evaluation summary ES1, which comprises the individual scores for the indicators “correctness”, “creativity”, “readability”, “completeness” and “rationality”. The summary feedback module 320 can choose whether to inform the user with the lower scored indicators. If choosing to inform the lower scored indicators, the summary feedback module 320 will specifically mark the lower scored indicator s “creativity” and “completeness” in the first evaluation summary ES1 (for example, using graphic formats to mark them in bright colors), and the suggestions of adjustment for the indicators “creativity” and “completeness” will be adopted in the first evaluation summary ES1.

TABLE 3-2

| | Individual | (V) | (X) | (V) | (X) | (V) |
|---|---|---|---|---|---|---|
| Indicators | scores | Correctness | Creativity | Readability | Completeness | Reasonability |
| Correctness | 8 | | | | | |
| Creativity | 5 | | | | | |
| Readability | 9 | | | | | |
| Completeness | 6 | | | | | |
| Rationality | 8 | | | | | |

| | |
|---|---|
| Suggestions of | The answer part lacks novelty. It is recommended to add unique strategies or insights |
| adjustment for | from different fields. |
| creativity | |
| Suggestions of | The answer part only provides a basic framework but lacks operational details and |
| adjustment for | steps. It is recommended to add specific guidance and solutions. |
| completeness | |

Then, the summary feedback module 320 transmits the first evaluation summary ES1 to the collection unit 100, and the user interface of the collection unit 100 presents the first evaluation summary ES1 to the user 50. The user 50 can adjust the originally provided first dataset DS1 based on the suggestions of adjustment of the first evaluation summary ES1, so as to generate the second dataset DS2. The user 50 can perform any kinds of adjustments on the portion of the first dataset DS1 that does not meet the evaluation criteria, such as (but not limited to): cleaning, pruning process or refining. The pruning process is, for example (but not limited to): pruning the portion of the first dataset DS1 that causes the scores of indicators to decrease.

For example, user 50 adjusts the answer part of the first dataset DS1 as “When having difficulties, it is a wise solution to seek help from others. The following are reference methods: (1) Identify trustable ones; (2) Share difficulties honestly; (3) Listen to others' suggestions; (4) Cooperate with others; (5) Make action plans; (6) Appreciate the support of others”, so as to form the second dataset DS2.

Then, the collection unit 100, the evaluation unit 200 and the feedback unit 300 process the second dataset DS2 in the same manner as the first dataset DS1. For example, the language evaluation module 220 of the evaluation unit 200 evaluates the second dataset DS2 based on the indicators “correctness”, “creativity”, “readability”, “completeness” and “rationality” to generate the second evaluation result ER2, in which the individual scores for the above indicators are 9 points, 7 points, 10 points, 8 points and 9 points. Furthermore, the above individual scores are weighted to obtain the total score of the second evaluation result ER2, as shown in Table 3-3.

TABLE 3-3

| | | | | Total score of |
|---|---|---|---|---|
| | | Individual | Weighted | second evaluation |
| Indicators | Weight | score | score | result ER2 |
| Correctness | 0.3 | 9 | 2.7 | 8.6 |
| Creativity | 0.2 | 7 | 1.4 | |
| Readability | 0.2 | 10 | 2.0 | |
| Completeness | 0.1 | 7 | 0.7 | |
| Rationality | 0.2 | 9 | 1.8 | |

The language evaluation module 220 determines whether the second evaluation result ER2 meets the evaluation criteria. In the example in Table 3-3, the individual scores of the indicator “creativity” and the indicator “completeness” are still lower than the predefined threshold, indicating that the second dataset DS2 has not reached the predefined quality and still cannot be used as pre-training data. The language evaluation module 220 generates suggestions of adjustment for the lower scored indicators “creativity” and “completeness”, comprising: “Suggestions of adjustment for creativity: although the content of the answer part is practical, it lacks innovative elements. It is recommended to add different cultures or psychology from a scientific perspective, and to provide non-traditional help-seeking methods or strategies, such as using technology tools or social media” and “Suggestions of adjustment for completeness: in the first step (identifying trustworthy people) and the fifth step (developing an action plan), it is recommended to provide specific examples so that readers can better understand and apply it.” The above suggestions of adjustment are also adopted in the second evaluation result ER2 and sent to the feedback unit 300.

The conversion module 310 of the feedback unit 300 converts the second evaluation result ER2 into simple text, numbers or graphics. Furthermore, the summary feedback module 320 aggregates the converted second evaluation result ER2b to generate a second evaluation summary ES2. The second evaluation summary ES2 is shown in Table 3-4.

TABLE 3-4

| | Individual | (V) | (X) | (V) | (X) | (V) |
|---|---|---|---|---|---|---|
| Indicators | scores | Correctness | Creativity | Readability | Completeness | Reasonability |
| Correctness | 9 | | | | | |
| Creativity | 7 | | | | | |
| Readability | 10 | | | | | |
| Completeness | 7 | | | | | |
| Rationality | 9 | | | | | |

| | |
|---|---|
| Suggestions of | The content in the answer part is practical but lacks innovative elements. It is |
| adjustment for | recommended to add different cultural or psychological perspectives and provide |
| creativity | non-traditional help-seeking methods or strategies, such as using technology tools or |
| | social media. |
| Suggestions of | In the first step (identifying trustworthy people) and the fifth step (developing an action |
| adjustment for | plan), it is recommended to provide specific examples so that readers can better |
| completeness | understand and apply. |

The second evaluation summary ES2 is sent to the collection unit 100 to be presented to the user 50. The user 50 adjusts the second dataset DS2 based on the second evaluation summary ES2 to generate a third dataset DS3 (not shown in the figures). For example, the answer part of the second dataset DS2 is adjusted as “When having difficulties, it is a wise solution to seek help from others. The following are complete answers: (1) Identify trustworthy people: first, ensure you seek help from trusted people. Trusted people may be family, friends, colleagues or mentors . . . (4) Cooperate with others: work as a team with others to find solutions together . . . (6) Appreciate the support of others: when you get help and after you find a solution, be grateful to those who support you . . . ”.

Moreover, similar to the processing manner of the first dataset DS1 and the second dataset DS2, the language evaluation module 220 evaluates the third dataset DS3 to obtain the third evaluation result ER3 based on the indicators “correctness”, “creativity”, “readability”, “completeness” and “rationality”, which comprises the individual scores of the above indicators and the total score after weighted calculation, as shown in Table 3-5.

TABLE 3-5

| | | | | Total score of third |
|---|---|---|---|---|
| | | Individual | Weighted | evaluation result |
| Indicators | Weight | score | score | ER3 |
| Correctness | 0.3 | 10 | 3.0 | 9.5 |
| Creativity | 0.2 | 8 | 1.6 | |
| Readability | 0.2 | 10 | 2.0 | |
| Completeness | 0.1 | 9 | 0.9 | |
| Rationality | 0.2 | 10 | 2.0 | |

In the third evaluation result ER3, the individual scores of each indicator have reached the predefined threshold (the predefined threshold is 8 points), indicating that the third dataset DS3 has passed the evaluation, and the third dataset DS3 has reached predefined quality and can be used as pre-training data. The language evaluation module 220 transmits the third evaluation result ER3 to the feedback unit 300. The summary feedback module 320 of the feedback unit 300 aggregates the third evaluation result ER3 into a third evaluation summary ES3, as shown in Table 3-6.

TABLE 3-6

| | Individual | (V) | (V) | (V) | (V) | (V) |
|---|---|---|---|---|---|---|
| Indicators | scores | Correctness | Creativity | Readability | Completeness | Reasonability |
| Correctness | 10 | | | | | |
| Creativity | 8 | | | | | |
| Readability | 10 | | | | | |
| Completeness | 9 | | | | | |
| Rationality | 10 | | | | | |

All indicators have passed the evaluation

The third evaluation summary ES3 is sent to the collection unit 100 and presented to the user 50. The user 50 knows from the third evaluation summary ES3 that the third dataset DS3 has passed the evaluation, and there is no need to adjust the third dataset DS3. Therefore, the third dataset DS3 can be stored in the storage unit 400.

Please refer to FIG. 1 again, the storage unit 400 is coupled to the evaluation unit 200 to selectively receive the first dataset DS1. More specifically, when the first evaluation result ER1 of the first dataset DS1 meets the evaluation criteria (individual score of each indicator reaches the predefined threshold), the storage unit 400 receives the first dataset DS1 for storage.

On the other hand, when the first evaluation result ER1 of the first dataset DS1 does not meet the evaluation criteria (any indicator does not reach the predefined threshold), the user 50 adjusts the originally provided first dataset DS1 to form the second dataset DS2, and the user 50 inputs the second dataset DS2 through the collection unit 100. Then, the second dataset DS2 is processed in a similar manner to the first dataset DS1, comprising: the evaluation unit 200 analyzes the second dataset DS2 to generate a category analysis result, and the evaluation unit 200 evaluates the second dataset DS2 based on the evaluation rule RL to generate a second evaluation result ER2, and the storage unit 400 selectively receives and stores the second dataset DS2 based on the second evaluation result ER2. If the second evaluation result ER2 still does not meet the evaluation criteria, the user 50 adjusts the second dataset DS2 to form the third dataset DS3, and process the third dataset DS3 based on the processing manner similar to the first dataset DS1 and the second dataset DS2.

Next, please refer to Table 4-1 to Table 4-3 (and refer to FIGS. 1 to 3) to describe another embodiment of operation of the data processing device 1000, which is described taking the fourth dataset DS4, the fifth dataset DS5 and the sixth dataset DS6 as examples. The user 50 first inputs the fourth dataset DS4 for evaluation. The fourth evaluation result ER4 of the fourth dataset DS4 does not meet the evaluation criteria, so the user 50 adjusts the fourth dataset DS4 to obtain the fifth dataset DS5. However, the fifth evaluation result ER5 of the fifth dataset DS5 still does not meet the evaluation criteria, so the user 50 adjusts the fifth dataset DS5 to obtain the sixth dataset DS6. The sixth evaluation result ER6 of the sixth dataset DS6 has met the evaluation criteria, so the sixth dataset DS6 can be stored in the storage unit 400 as pre-training data for the language model.

More specifically, the fourth dataset DS4 is also an open question and answer category. The question part of the fourth dataset DS4 is: “What new technological breakthroughs and product innovations will there be in the future?”, and the answer part of the fourth dataset DS4 is: “the development of artificial intelligence, quantum computing, biotechnology, renewable energy and other fields. These fields continue to evolve and may bring exciting new technologies and products”. Still taking the five indicators “correctness”, “creativity”, “readability”, “completeness” and “rationality” of the evaluation rule RL as examples, the language evaluation module 220 evaluates the fourth dataset DS4 to obtain the fourth evaluation result ER4. The individual scores of the indicators “creativity” and “completeness” are lower than the predefined threshold (the predefined threshold is set to 8 points), so the language evaluation module 220 generates suggestions of adjustment to the indicators “creativity” and “completeness”, such as: “Suggestions of adjustment for creativity: the current answer part can be more creative, such as mentioning emerging and unknown technology fields or unique application cases to demonstrate in-depth insights into future technology trends” and “Suggestions of adjustment for completeness: the answer part can be more complete and should comprise predictions or examples of specific technological breakthroughs or product innovations in the mentioned technology fields, as well as prospects for how these innovations will specifically impact society and daily life”. Furthermore, the summary feedback module 320 aggregates the fourth evaluation result ER4 to generate the fourth evaluation summary ES4, as shown in Table 4-1.

TABLE 4-1

| | Individual | (V) | (X) | (V) | (X) | (V) |
|---|---|---|---|---|---|---|
| Indicators | scores | Correctness | Creativity | Readability | Completeness | Reasonability |
| Correctness | 9 | | | | | |
| Creativity | 5 | | | | | |
| Readability | 10 | | | | | |
| Completeness | 6 | | | | | |
| Rationality | 8 | | | | | |

| | |
|---|---|
| Suggestions of | The current answer section can be more creative, such as mentioning emerging and |
| adjustment for | unknown technology areas or unique application cases to demonstrate in-depth |
| creativity | insights into future technology trends. |
| Suggestions of | The current answer section could be more complete and should comprise predictions |
| adjustment for | or examples of specific technological breakthroughs or product innovations in the |
| completeness | technology areas mentioned, as well as prospects for how these innovations will |
| | specifically impact society and daily life. |

Since the individual scores of the indicators “creativity” and “completeness” in the fourth evaluation result ER4 are lower than the predefined threshold, the user 50 must adjust the fourth dataset DS4 to form the fifth dataset DS5 and perform evaluation again. For example, the answer part of the fourth dataset DS4 is adjusted as: “The application expansion of machine learning and artificial intelligence, the practical application of quantum computing, biotechnology, renewable energy innovation, the application expansion of block-chain technology, and virtual reality and augmentation” Reality. These technical fields are constantly developing, and various exciting new technologies and products will appear in the future” so as to form the fifth dataset DS5.

The language evaluation module 220 evaluates the fifth dataset DS5 to obtain the fifth evaluation result ER5, in which the individual scores of the indicators “creativity” and “completeness” are still lower than the predefined threshold, hence, generating suggestions of adjustment as: “Suggestions of adjustment for creativity: although the current answer covers multiple technical fields, it can be more creative, and it is recommended to provide expected specific product innovations, or advanced technologies under development” and “Suggestions of adjustment for completeness: the current answer can be more complete, and it is recommended to comprise specific predictions of future technological developments, such as possible products, solutions, or how these technologies can solve current global problems”. Furthermore, the summary feedback module 320 aggregates the fifth evaluation result ER5 to generate the fifth evaluation summary ES5, as shown in Table 4-2.

TABLE 4-2

| | Individual | (V) | (X) | (V) | (X) | (V) |
|---|---|---|---|---|---|---|
| Indicators | scores | Correctness | Creativity | Readability | Completeness | Reasonability |
| Correctness | 9 | | | | | |
| Creativity | 7 | | | | | |
| Readability | 10 | | | | | |
| Completeness | 7 | | | | | |
| Rationality | 9 | | | | | |

| | |
|---|---|
| Suggestions of | While current answers cover multiple technology fields, they can be more creative |
| adjustment for | and suggest specific product innovations that are expected or advanced |
| creativity | technologies that are under development. |
| Suggestions of | Current answers could be more complete, and suggestions comprise specific |
| adjustment for | predictions of future technological developments, such as possible products, |
| completeness | solutions, or how these technologies may solve current global problems. |

Similarly, since the individual scores of the indicators “creativity” and “completeness” in the fifth evaluation result ER5 are still lower than the predefined threshold, the user 50 adjusts the answer part of the fifth dataset DS5 as: “Future technological breakthroughs and product innovations will continue to emerge, comprising: (1) Expansion of machine learning and artificial intelligence applications: Artificial intelligence will be more widely used in healthcare, autonomous driving, financial fields, etc., bringing more intelligent solutions Plan. (2) Practical implementation of quantum computing: Quantum computing is expected to achieve major breakthroughs in the fields of encryption, materials science and drug research and development . . . (4) Application expansion of block-chain technology: Block-chain will be used in supply chain management, voting systems and find more applications in fields such as smart contracts . . . ”, so as to form the sixth dataset DS6.

The language evaluation module 220 evaluates the sixth dataset DS6 to obtain the sixth evaluation result ER6, and the summary feedback module 320 aggregates the sixth evaluation result ER6 to generate the sixth evaluation summary ES6, as shown in Table 4-3.

TABLE 4-3

| | Individual | (V) | (V) | (V) | (V) | (V) |
|---|---|---|---|---|---|---|
| Indicators | scores | Correctness | Creativity | Readability | Completeness | Reasonability |
| Correctness | 10 | | | | | |
| Creativity | 8 | | | | | |
| Readability | 10 | | | | | |
| Completeness | 8 | | | | | |
| Rationality | 10 | | | | | |

All indicators have passed the evaluation

The user 50 can know from the sixth evaluation summary ES6 that the scores of each indicator have reached the predefined threshold, which means that there is no need to adjust the sixth dataset DS6. The sixth dataset DS6 can be stored in the storage unit 400 as suitable pre-training data.

As shown in the examples of Table 3-1 to Table 3-6, the data processing device 1000 of the present disclosure provides the first evaluation summary ES1 and the second evaluation summary ES2, and the user 50 adjusts the originally provided first dataset DS1 to form the second dataset DS2 based on the first evaluation summary ES1, and then adjusts the second dataset DS2 to form the third dataset DS3 based on the second evaluation summary ES2. The third dataset DS3 is more improved for “creativity” and “completeness” and is more suitable as pre-training data for language models. Similarly, in the examples in Table 4-1 to Table 4-3, user 50 adjusts the fourth dataset DS4 to form the fifth dataset DS5, and the user 50 further adjusts the fifth dataset DS5 to form the sixth dataset DS6 with better “creativity” and “completeness”. In other words, diverse datasets are more suitable for pre-training language models, which improves the performance of pre-trained and refined language models.

Next, please refer to FIG. 4, which illustrates a schematic diagram of performance of a language model trained by diverse datasets. The dataset DS(A) is a base dataset with a low degree of diversity, which is, e.g., a single question and answer set. The basic dataset can be processed differently (such as, word replacement by program, word modification by large language model, question and answer designing and word modification by large language model, or manual revision) to obtain diverse datasets. For example, combining the dataset DS(A) with an expanded question and answer of “in other words” to obtain the dataset DS(B), which has a higher degree of diversity. Moreover, the dataset DS(B) is further combined with an expansion of “brief description” to obtain a dataset DS(C) with a much higher degree of diversity.

The datasets DS(A), DS(B) and DS(C) are respectively provided to the large language model 2220 for pre-training and refining to obtain refined large language models 2220A, 2220B and 2220C. The verification results show that, the inference result IF_A of the refined large language model 2220A reaches the score “59k”. Moreover, the inference result IF_B of the large language model 2220B which is refined with the dataset DS(B) of a higher degree of diversity, may reach a higher score of “85k”. Furthermore, the inference result IF_C of the large language model 2220C which is refined with the more diverse dataset DS(C), may reach a much higher score of “129k”.

FIG. 5 is a flow chart of a data processing method based on an embodiment of the present disclosure. The data processing method of this embodiment can be implemented by each device component of the embodiments in FIGS. 1 to 3. First, step S500 is executed: the collection unit 100 receives the first dataset DS1 originally provided by the user 50. Furthermore, the collection unit 100 transmits the first dataset DS1 to the evaluation unit 200. Next, step S502 is executed: using the condition and category analysis module 210 of the evaluation unit 200 to set the predefined condition for evaluation of the first dataset DS1, such as: setting the indicators and weights of the evaluation rule RL and setting the initial prompts for conducting the evaluation.

Next, step S504 is executed: the first dataset DS1 is analyzed by the condition and category analysis module 210 to determine whether the first category TP1 of the first dataset DS1 meets the predefined categories for evaluation. Next, step S506 is executed: the language evaluation module 220 of the evaluation unit 200 evaluates the first dataset DS1 based on the evaluation rule RL, so as to generate a first evaluation result ER1. Next, step S508 is performed: using the language evaluation module 220 to determine whether the first evaluation result ER1 does not meet the evaluation criteria (for example, whether the individual scores of each indicator reach a predefined threshold), so as to confirm whether the first dataset DS1 reaches predefined quality.

If the determination result of step S508 is “yes”, i.e., the first evaluation result ER1 meets the evaluation criteria, then step S510 is executed: the language evaluation module 220 transmits the first dataset DS1 to the storage unit 400 for storage. If the determination result of step S508 is “no”, i.e., the first evaluation result ER1 does not meet the evaluation criteria (for example, the individual score of any indicator does not reach the predefined threshold), then step S512 is executed: language evaluation model 220 transmits the first evaluation result ER1 to the conversion module 310 of the feedback unit 300. The first evaluation result ER1 is converted into text, numbers, graphics or images in appropriate formats by the conversion module 310, so as to generate the converted first evaluation result ER1b.

After step S512, step S514 is then executed: the summary feedback module 320 aggregates the converted first evaluation result ER1 b, so as to generate a first evaluation summary ES1. The first evaluation summary ES1 comprises, e.g., individual scores of the indicators in the first evaluation result ER1. Next, step S516 is executed: the summary feedback module 320 selectively marks indicators with lower scores (e.g., indicators with individual scores not reaching the predefined threshold) in the first evaluation summary ES1. Moreover, suggestions of adjustment for the first dataset DS1 are selectively adopted in the first evaluation summary ES1.

Next, step S518 is executed: the summary feedback module 320 transmits the first evaluation summary ES1 to the collection unit 100, and the collection unit 100 outputs the first evaluation summary ES1 to the user 50. Next, step S520 is executed: the user 50 will adjust the originally provided first dataset DS1 to generate a second dataset DS2, based on the first evaluation summary ES1. Then, steps S500 to S520 are re-executed: the second dataset DS2 is processed based on the same processing manner as the first dataset DS1.

In summary, the data processing device 1000 and the data processing method of the present disclosure have an improved data processing mechanism and can provide datasets with a good quality (e.g., the adjusted third dataset DS3 in Table 3-4 and Table 3-5) to serve as pre-training data for the language model. When the user 50 inputs the dataset, the dataset can be adjusted in real time using an automated and quantifiable evaluation mechanism. In other words, in the early collection stage of the dataset, the dataset can be adjusted to improve quality and hence reduce labor and time costs required for human evaluation and filtering. Moreover, when the language model is refined for a specific task, the required post-processing cost can also be reduced.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A data processing device, for providing a pre-training data for a language model, comprising:
a collection unit, for receiving a first dataset, and the first dataset has a first category;
an evaluation unit, for analyzing the first dataset based on the first category to generate a category analysis result, evaluating the first dataset based on a plurality of indicators of an evaluation rule to generate a first evaluation result, and determining whether the first evaluation result meets an evaluation criteria;
a feedback unit, for converting and aggregating the first evaluation result to generate a first evaluation summary, and transmitting the first evaluation summary to the collection unit; and
a storage unit, for selectively storing the first dataset based on the first evaluation result,
wherein, when the first evaluation result meets the evaluation criteria, the storage unit stores the first dataset and the first dataset serves as the pre-training data, when the first evaluation result does not meet the evaluation criteria, the evaluation unit provides a plurality of suggestions of adjustment for the first dataset.

2. The data processing device of claim 1, wherein the first dataset has a text format or a voice format, and the collection unit comprising:
a user interface, for inputting the first dataset.

3. The data processing device of claim 1, wherein the evaluation unit comprising:
a condition and category analysis module, for setting a predefined condition for evaluating of the first dataset,
wherein, the predefined condition comprises the indicators of the evaluation rule and a set of initial prompts for evaluating the first dataset.

4. The data processing device of claim 3, wherein the indicators at least comprise a correctness, a creativity, a readability, a completeness and a rationality of the first dataset.

5. The data processing device of claim 3, wherein the condition and category analysis module is further used to determine whether the first category conforms to a predefined category,
wherein, the predefined category comprises at least an open question and answer category and a closed question and answer category.

6. The data processing device of claim 3, wherein the evaluation unit further comprising:
a language evaluation module, for evaluating the first dataset based on the evaluation rule to generate the first evaluation result,
wherein, the first evaluation result comprises an individual score for each of the indicators and a total score for all the indicators, and the language evaluation module determines whether the individual score for each of the indicators is greater than a predefined threshold.

7. The data processing device of claim 6, wherein the language evaluation module utilizes an external language model to define the evaluation rule.

8. The data processing device of claim 1, wherein the feedback unit comprising:
a conversion module, for performing a conversion process on the first evaluation result, and the first evaluation result, which is converted, selectively marks the indicators whose individual scores are lower than the predefined threshold.

9. The data processing device of claim 8, wherein the feedback unit further comprising:
a summary feedback module, for aggregating the first evaluation result which is converted, so as to generate the first evaluation summary,
wherein, the first evaluation summary selectively adopts the suggestions of adjustment for the first dataset, and the suggestions of adjustment are related to the indicators whose individual scores are lower than the predefined threshold.

10. A data processing method, for providing a pre-training data for a language model, comprising:
receiving a first dataset by a collection unit, and the first dataset has a first category;
analyzing the first dataset based on the first category to generate a category analysis result, evaluating the first dataset based on a plurality of indicators of an evaluation rule to generate a first evaluation result, and determining whether the first evaluation result meets an evaluation criteria, by an evaluation unit;
converting and aggregating the first evaluation result to generate a first evaluation summary by a feedback unit; and
selectively storing the first dataset based on the first evaluation result, by a storage unit,
wherein, when the first evaluation result meets the evaluation criteria, the following steps are performed:
storing the first dataset by the storage unit; and
providing the first dataset as the pre-training data,
when the first evaluation result does not meet the evaluation criteria, the following steps are performed:
providing a plurality of suggestions of adjustment for the first dataset by the evaluation unit.

11. The data processing method of claim 10, wherein the first dataset has a text format or a voice format, and the step of receiving a first dataset comprising:
inputting the first dataset through a user interface of the collection unit.

12. The data processing method of claim 10, before the step of analyzing the first dataset based on the first category, further comprising:
setting a predefined condition for evaluating of the first dataset by a condition and category analysis module of the evaluation unit,
wherein, the predefined condition comprises the indicators of the evaluation rule and a set of initial prompts for evaluating the first dataset.

13. The data processing method of claim 12, wherein the indicators at least comprise a correctness, a creativity, a readability, a completeness and a rationality of the first dataset.

14. The data processing method of claim 12, wherein the step of analyzing the first dataset based on the first category comprising:
determining whether the first category conforms to a predefined category by the condition and category analysis module,
wherein, the predefined category comprises at least an open question and answer category and a closed question and answer category.

15. The data processing method of claim 12, wherein the step of evaluating the first dataset to generate the first evaluation result comprising:
evaluating the first dataset based on the evaluation rule to generate the first evaluation result by a language evaluation module of the evaluation unit,
wherein, the first evaluation result comprises an individual score for each of the indicators and a total score for all the indicators, and the language evaluation module determines whether the individual score for each of the indicators is greater than a predefined threshold.

16. The data processing method of claim 15, which before the step of evaluating the first dataset based on the evaluation rule, further comprising:
defining the evaluation rule by the language evaluation module utilizing an external language model.

17. The data processing method of claim 10, wherein the step of converting and aggregating the first evaluation result to generate the first evaluation summary comprising:
performing a conversion process on the first evaluation result by a conversion module of the feedback unit; and
in the first evaluation result which is converted, selectively marking the indicators whose individual scores are lower than the predefined threshold.

18. The data processing method of claim 17, wherein the step of converting and aggregating the first evaluation result to generate the first evaluation summary further comprising:
aggregating the first evaluation result which is converted, so as to generate the first evaluation summary, by a summary feedback module of the feedback unit,
wherein, the first evaluation summary selectively adopts the suggestions of adjustment for the first dataset, and the suggestions of adjustment are related to the indicators whose individual scores are lower than the predefined threshold.
